(19) United States
(12) Patent Application Publication
(10) Pub. No.: US 2026/0008632 A1
(43) Pub. Date: Jan. 8, 2026

(54) PRODUCT COLLECTION DEVICE

(71) Applicant: CHENG MEI MACHINE CO., LTD., Taoyuan City (TW)

(72) Inventor: Yung-Hsuan CHEN, Taoyuan City (TW)

(21) Appl. No.: 19/260,701

(22) Filed: Jul. 7, 2025

(30) Foreign Application Priority Data
Jul. 8, 2024 (TW) 113207350

(51) Int. Cl. B65G 47/248; B65G 47/88; B65G 57/03

(52) U.S. Cl. CPC B65G 47/248; B65G 47/88; B65G 57/03

(57) ABSTRACT

A product collection device includes a flipping module and a separation-pushing plate module. The flipping module includes a rotating element and a flipping jig. The flipping jig includes a first row collecting rack set and a second row collecting rack set. The flipping jig is flipped by the rotating element such that the inlets of the first and second row collecting rack sets are transformed from being parallel to a first direction to being parallel to a second direction. The separation-pushing plate module includes a multi-link assembly and a pushing plate. After the inlets are parallel to the second direction, the multi-link assembly drives the pushing plate to move along the second direction to push the plastic parts in the first row collecting rack set. Next, the multi-link assembly drives the pushing plate to push the plastic parts in the second row collecting rack set.

### BACKGROUND OF THE INVENTION

### (a) Field of the Invention

The present disclosure relates to a product collection device, and it especially relates to the product collection device which may collect the products such as cup lids and then transport the products to a packaging equipment for packaging purposes.

### (b) Description of the Prior Art

In general, conventional product conveying devices typically require multiple conveying steps to transfer processed products to a packaging equipment. However, such multiple conveying steps may reduce overall operating efficiency. Moreover, the number of the processed products that a processing module on conveying device can process per cycle is limited, such that difficulty in collecting and transferring processed products which are from different processing steps at one time. This increases the number of conveying steps, thereby reducing the packaging speed of the packaging equipment.

For example, due to space limitations, the processing equipment for formed cup lids may only output 25 cup lids per cycle. However, the client requires packaging in the unit of 50 cup lids. As a result, the multiple conveying steps are required before packaging the cup lids. In some cases, manual steps may be required to stack the two batches of 25 cup lids together to achieve the unit of 50 cup lids.

### SUMMARY OF THE INVENTION

One aspect of the present disclosure provides a product collection device for rotating products such as cup lids by 90 degrees through a flipping jig to align with a separation-pushing plate module. The separation-pushing plate module stacks at least two sets of the cup lids into a single unit, and the products may be subsequently transferred to a packaging equipment.

According to an embodiment of the present disclosure, a product collection device means for collecting and transporting a plurality of plastic parts and includes a flipping module and a separation-pushing plate module. The flipping module has a rotating element and a flipping jig pivotally connected to the rotating element. The flipping jig includes a first row collecting rack set and a second row collecting rack set adjacent to the first row collecting rack set, after the first row collecting rack set and the second row collecting rack set receive the plurality of the plastic parts, the flipping jig is flipped by the rotating element, such that a plurality of inlets of the first row collecting rack set and the second row collecting rack set are transformed from being parallel to a first direction to being parallel to a second direction, and the first direction is perpendicular to the second direction. The separation-pushing plate module is disposed at one side of the flipping module and has a multi-link assembly and a pushing plate connected to the multi-link assembly. After the flipping module is flipped such that the plurality of the inlets are parallel to the second direction, the pushing plate is aligned with the first row collecting rack set, and the multi-link assembly drives the pushing plate to move along the second direction to push the plurality of the plastic parts in the first row collecting rack set through the plurality of the inlets, wherein the multi-link assembly drives the pushing plate to move so that the pushing plate is aligned with the second row collecting rack set, and the multi-link assembly of the separation-pushing plate module drives the pushing plate to move along the second direction to push the plurality of the plastic parts in the second row collecting rack set through the plurality of the inlets.

In one embodiment of the present disclosure, the plurality of the plastic parts pushed out from the second row collecting rack set are stacked onto the plurality of the plastic parts previously pushed out from the first row collecting rack set.

In one embodiment of the present disclosure, the product collection device further includes a first conveying module. The first conveying module is disposed at one side of the flipping module and configured to convey the plurality of the plastic parts to the first row collecting rack set and the second row collecting rack set of the flipping jig.

In one embodiment of the present disclosure, the first conveying module comprises a moving platform set and a lifting jig disposed on the moving platform set, and the moving platform set is configured to move the lifting jig so as to align the lifting jig with the flipping jig of the flipping module along the first direction.

In one embodiment of the present disclosure, the lifting jig of the first conveying module comprises a plurality of board brushes, and the plurality of the board brushes are configured to secure the plurality of the plastic parts within the lifting jig.

In one embodiment of the present disclosure, the board brushes of the first conveying module are disposed around a bottom portion of the lifting jig.

In one embodiment of the present disclosure, the product collection device further includes a second conveying module. The second conveying module is disposed at one side of the flipping module opposite to the separation-pushing plate module and configured to receive the plurality of the plastic parts pushed by the pushing plate of the separation-pushing plate module from the first row collecting rack set and second row collecting rack set.

In one embodiment of the present disclosure, the second conveying module comprises a plurality of plastic collection slots, each one of the plurality of the plastic collection slots is configured to sequentially receive the plurality of the plastic parts pushed from the first row collecting rack set and then receive the plurality of the plastic parts pushed from the second row collecting rack set, and another one of the plurality of the plastic collection slots is configured to receive the plurality of the plastic parts which may be pushed next from the first row collecting rack set and the second row collecting rack set.

In one embodiment of the present disclosure, the product collection device further includes a conveyor pushing set. The conveyor pushing set is disposed at one side of the second conveying module and having two opposite conveyor pushing plates, wherein the two conveyor pushing plates are configured to push out the plurality of the plastic parts received in the plurality of the plastic collection slots of the second conveying module, such the plurality of the plastic parts are configured to be packaged subsequently by a packaging equipment.

In one embodiment of the present disclosure, the conveyor pushing set comprises two gears and two belts respectively corresponding to the two gears, and the two belts are driven by the two gears to reciprocally move the two conveyor pushing plates.

In the embodiments of the present disclosure, after the flipping module of the product collection device receives the plastic parts, the flipping jig of the flipping module may be rotated 90 degrees by the rotating element to align with the separation-pushing plate module, such that the inlets of the first row collecting rack set and the second row collecting rack set are transformed from being parallel to the first direction to being parallel to the second direction. In addition, the pushing plate of the separation-pushing plate module may be aligned with the first row collecting rack set, and the multi-link assembly drives the pushing plate to move along the second direction to push out the plurality of the plastic parts in the first row collecting rack set. Subsequently, the multi-link assembly of the separation-pushing plate module may drive the pushing plate to move along the second direction to push out the plastic parts in the second row collecting rack set. In this manner, the plastic parts pushed out by the pushing plate in at least two operations may be conveyed to a packaging equipment for packaging, thereby improving overall operating efficiency.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a product collection device according to an embodiment of the present disclosure.

FIG. 2 is a perspective view of a lifting jig according to an embodiment of the present disclosure.

FIG. 3 is a schematic view illustrating a lifting jig securing plastic parts according to an embodiment of the present disclosure.

FIGS. 4 and 5 are schematic views illustrating that a lifting jig conveying plastic parts to a flipping jig according to some embodiments of the present disclosure.

FIGS. 6 and 7 are schematic views illustrating that a flipping jig of a flipping module is flipped according to some embodiments of the present disclosure.

FIGS. 8 to 11 are schematic views illustrating that a separation-pushing plate module is operated according to some embodiments of the present disclosure.

FIG. 12 is a schematic view illustrating that a conveyor pushing set is operated according to an embodiment of the present disclosure.

FIG. 13 is a perspective view of a conveyor pushing set according to an embodiment of the present disclosure.

FIG. 14 is a side view of a conveyor pushing set according to an embodiment of the present disclosure.

FIG. 15 is a schematic view illustrating that conveyor pushing plates of the conveyor pushing set are operated according to an embodiment of the present disclosure.

### DETAILED DESCRIPTION OF THE PREFERRED EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper,” “front,” “back” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

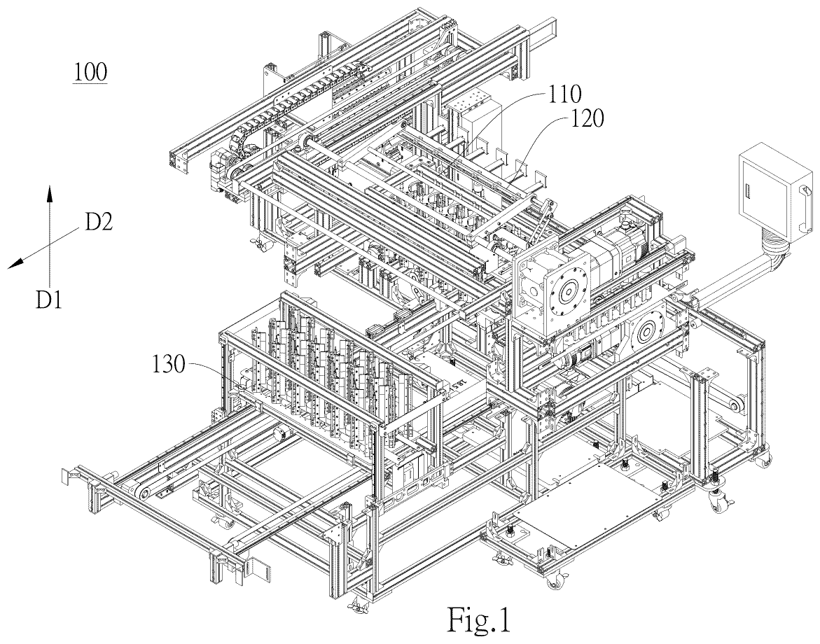

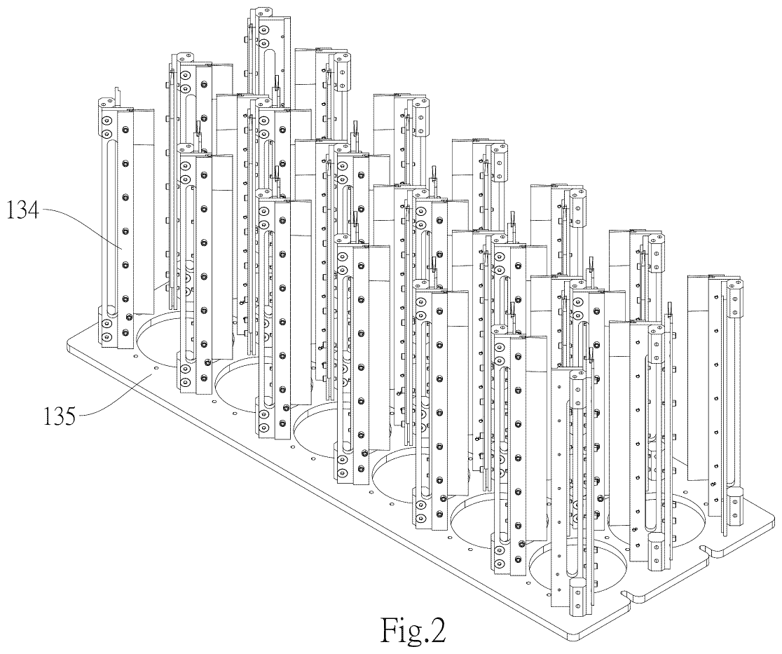

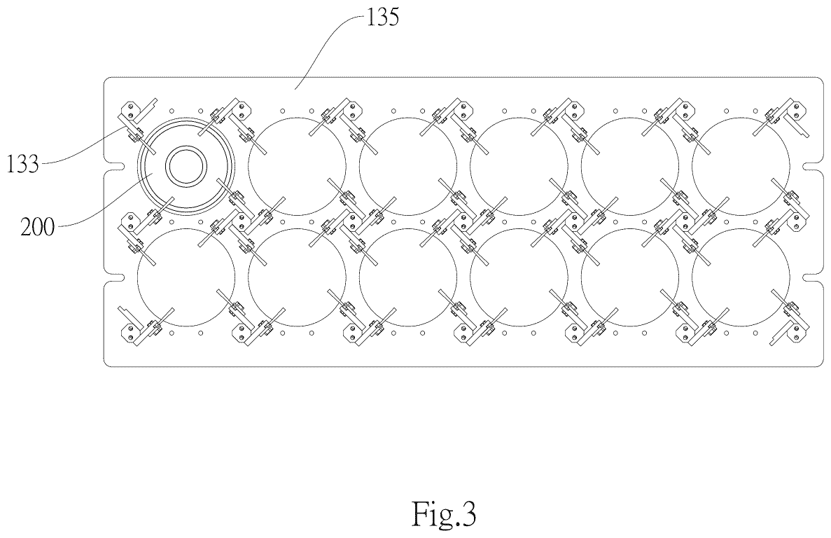

Please refer to FIG. 1 to FIG. 3, FIG. 1 is a perspective view of a product collection device 100 according to an embodiment of the present disclosure, FIG. 2 is a perspective view of a lifting jig 134 according to an embodiment of the present disclosure, and FIG. 3 is a schematic view illustrating the lifting jig 134 securing plastic parts 200 according to an embodiment of the present disclosure. As shown in FIG. 1 to FIG. 3, the product collection device 100 may be used to collect and transfer a plurality of the plastic parts 200. For example, the plastic parts 200 may be cup lids or other articles, and the form of the plastic parts 200 is not limited in this regard. In this embodiment, the product collection device 100 includes a flipping module 110, a separation-pushing plate module 120, and a first conveying module 130. The first conveying module 130 is disposed at one side of the flipping module 110. The first conveying module 130 is configured to convey the plastic parts 200 to a first row collecting rack set 116 and a second row collecting rack set 117 of a flipping jig 114 of the flipping module 110.

In some embodiments, the first conveying module 130 includes a moving platform set 132 and a lifting jig 134 disposed on the moving platform set 132. The moving platform set 132 of the first conveying module 130 is configured to move the lifting jig 134 so that the lifting jig 134 may align with the flipping jig 114 of the flipping module 110 along a first direction D1. In some embodiments, the lifting jig 134 of the first conveying module 130 has a plurality of board brushes 133. The board brushes 133 are configured to secure the plastic parts 200 within the lifting jig 134, so as to prevent the plastic parts 200 from falling out of the lifting jig 134 during transfer. In this embodiment, the board brushes 133 of the first conveying module 130 are disposed around a bottom portion 135 of the lifting jig 134, and the board brushes 133 may secure the plastic parts 200 within the lifting jig 134.

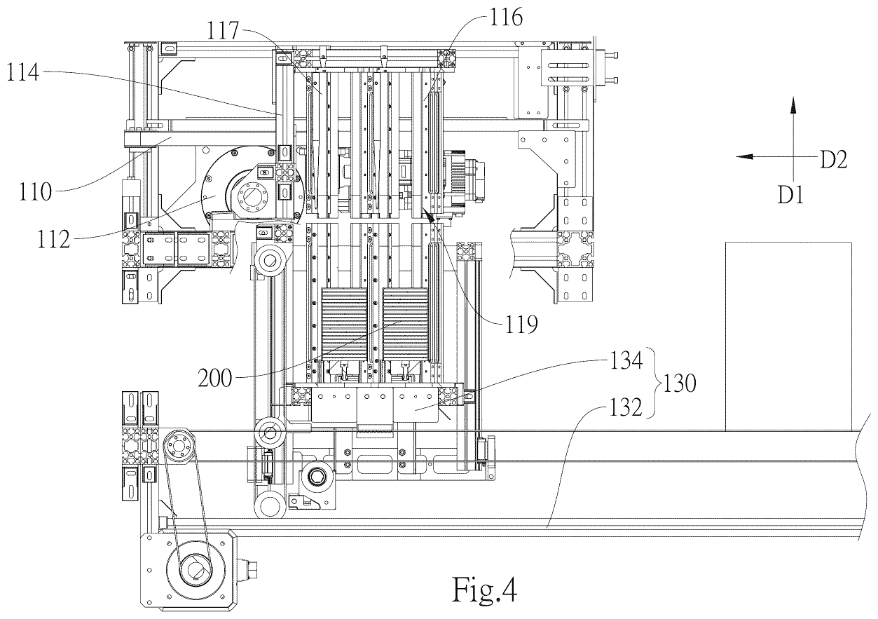

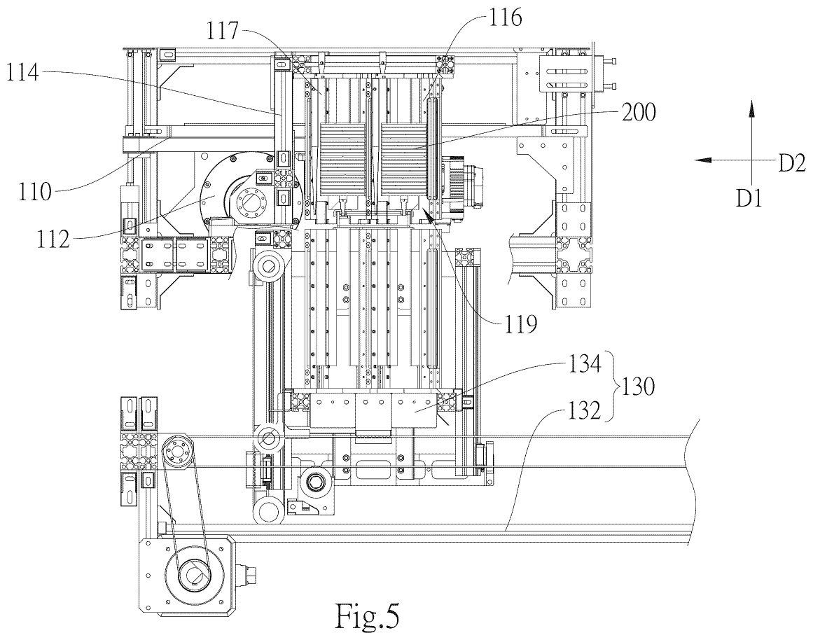

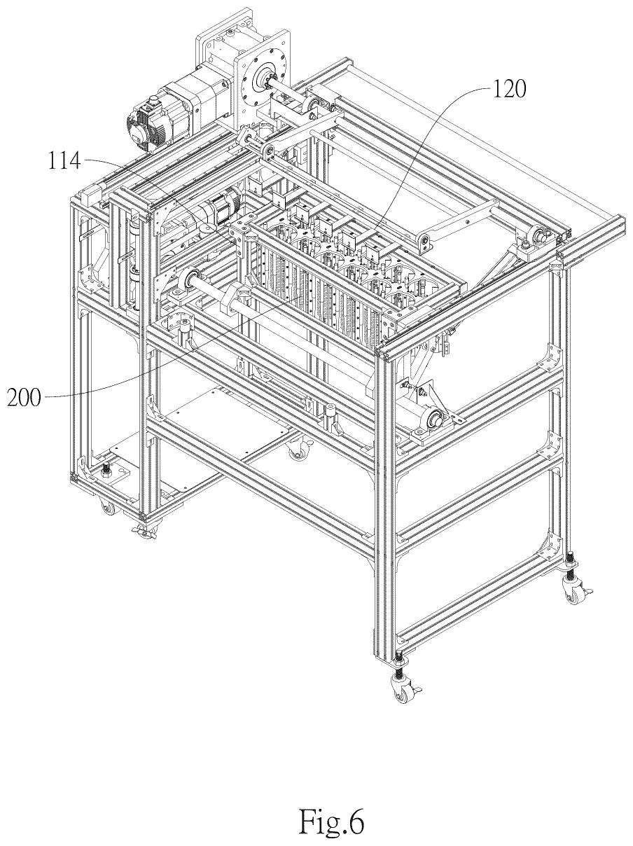

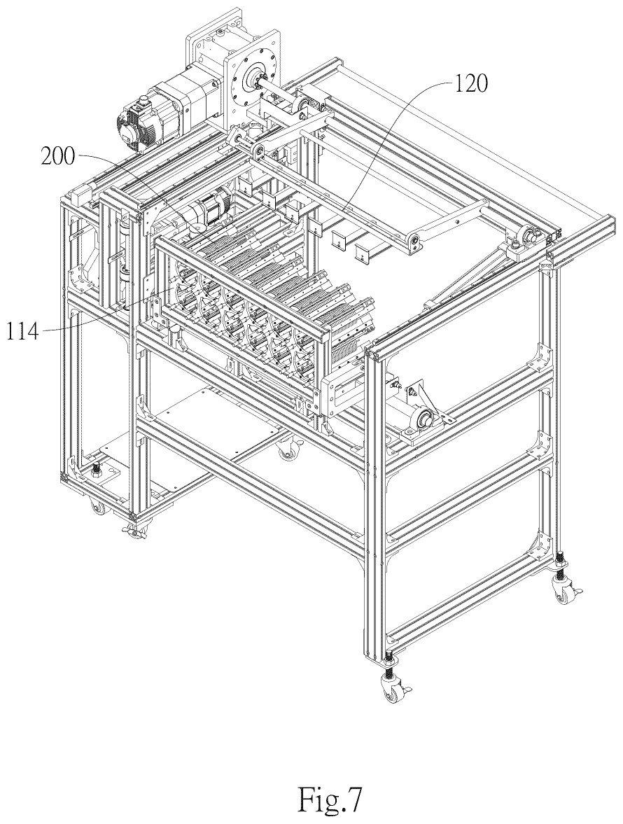

Please refer to FIG. 4 to FIG. 7, FIGS. 4 and 5 are schematic views illustrating that the lifting jig 134 conveys the plastic parts 200 to the flipping jig 114 according to some embodiments of the present disclosure, FIGS. 6 and 7 are schematic views illustrating that the flipping jig 114 of the flipping module 110 is flipped according to some embodiments of the present disclosure. As shown in FIG. 4 to FIG. 7, the plastic parts 200 which have been cut may be carried by the lifting jig 134 of the first conveying module 130. The moving platform set 132 of the first conveying module 130 may move the lifting jig 134 to a position directly below the flipping jig 114 of the flipping module 110. Then, as shown in FIG. 5, the first conveying module 130 may deliver the plastic parts 200 from the lifting jig 134 into the flipping jig 114 of the flipping module 110.

In some embodiments, the flipping module 110 includes a rotating element 112 and the flipping jig 114 pivotally connected to the rotating element 112. The flipping jig 114 includes the first row collecting rack set 116 and the second row collecting rack set 117 adjacent to the first row collecting rack set 116. Specifically, after the first row collecting rack set 116 and the second row collecting rack set 117 of the flipping jig 114 receive the plastic parts 200, the flipping jig 114 may be rotated by the rotating element 112, such that inlets 119 of the first row collecting rack set 116 and the second row collecting rack set 117 are transformed from being parallel to the first direction D1 to being parallel to a second direction D2. The first direction D1 is perpendicular to the second direction D2 as shown in FIG. 7.

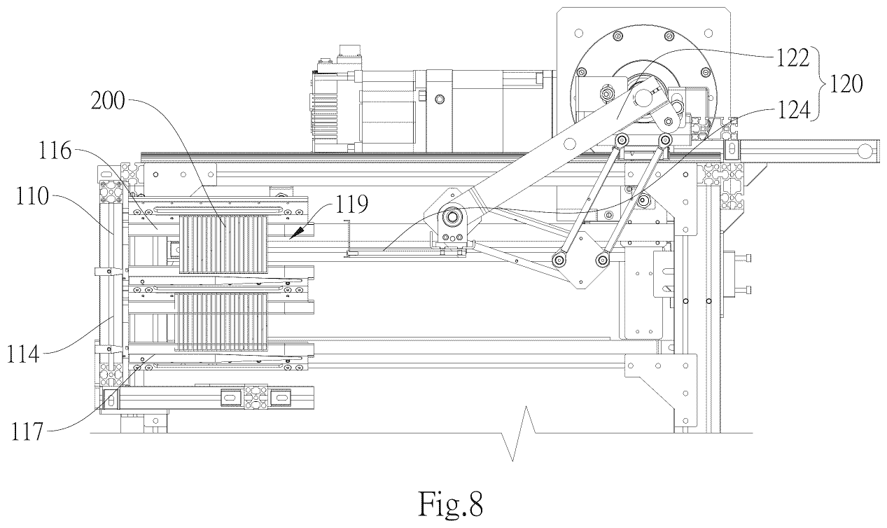

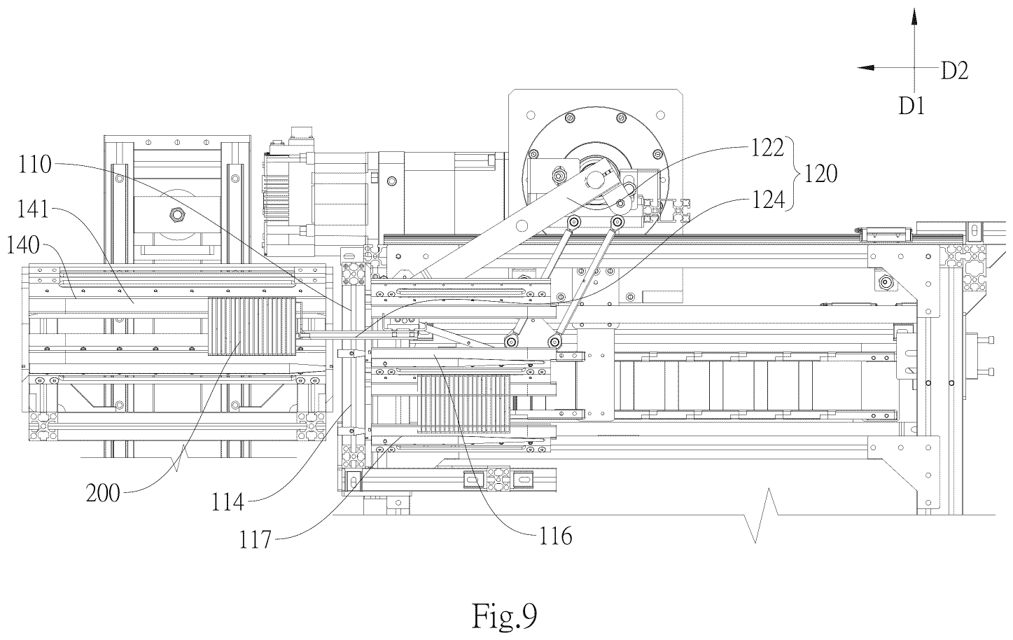

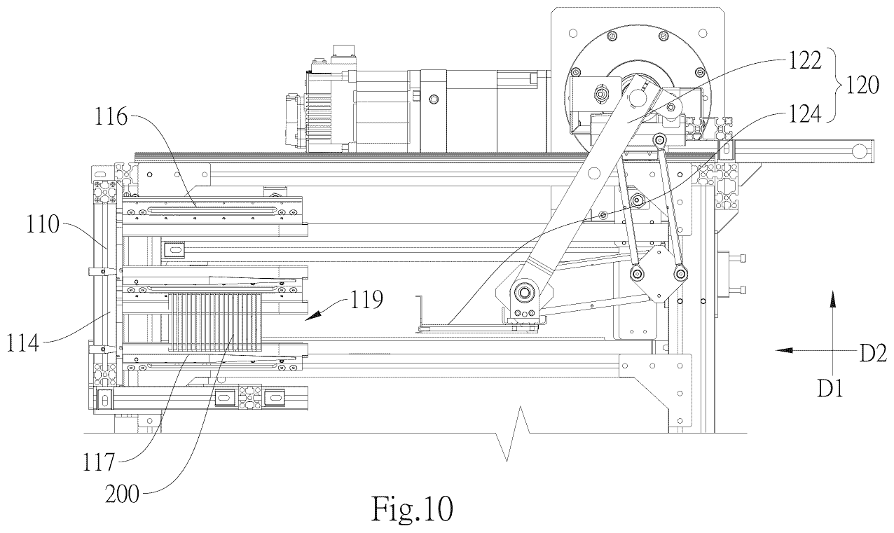

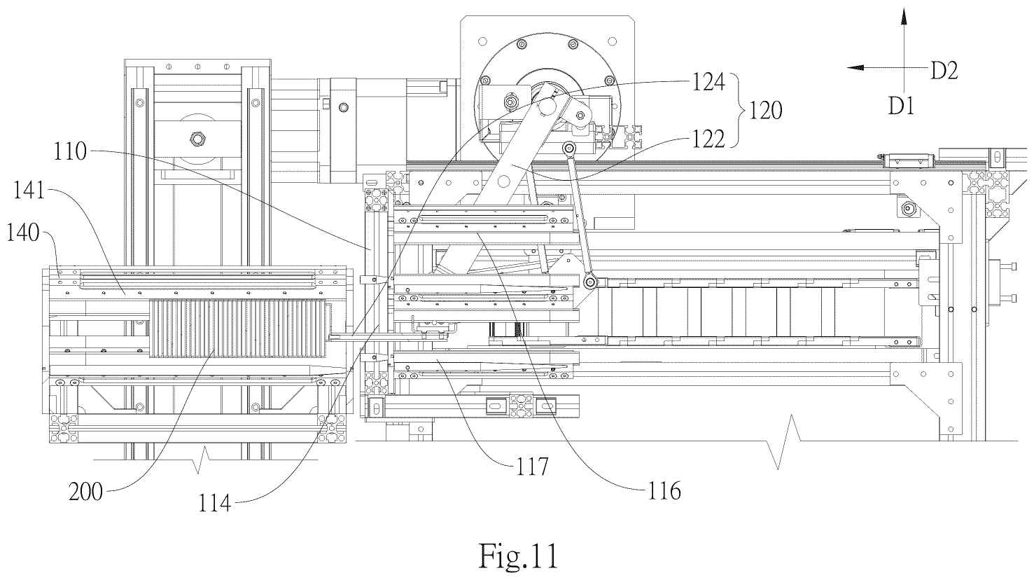

Please refer to FIG. 8 to FIG. 11, FIG. 8 to FIG. 11 are schematic views illustrating that the separation-pushing plate module 120 is operated according to some embodiments of the present disclosure. As shown in FIG. 8 to FIG. 11, the separation-pushing plate module 120 is disposed at one side of the flipping module 110 and includes a multi-link assembly 122 and a pushing plate 124 connected to the multi-link assembly 122. After the flipping jig 114 of the flipping module 110 is rotated such that the inlets 119 are parallel to the second direction D2, the pushing plate 124 may be moved and aligned with the first row collecting rack set 116. The multi-link assembly 122 may then drive the pushing plate 124 to move along the second direction D2 to push out the plurality of the plastic parts 200 in the first row collecting rack set 116, which corresponds to a first operation of pushing out the plastic parts 200 by the separation-pushing plate module 120.

Next, the multi-link assembly 122 of the separation-pushing plate module 120 may drive the pushing plate 124 to move such that the pushing plate 124 of the separation-pushing plate module 120 aligns with the second row collecting rack set 117. The multi-link assembly 122 of the separation-pushing plate module 120 may then drive the pushing plate 124 to move along the second direction D2, so as to push out the plurality of the plastic parts 200 in the second row collecting rack set 117 through the inlets 119, which corresponds to a second operation of pushing out the plastic parts 200 by the separation-pushing plate module 120. That is, the plastic parts 200 in both the first and second row collecting rack sets 116 and 117 may be pushed out sequentially by the configuration of the separation-pushing plate module 120.

For example, the 25 plastic parts 200 may be pushed out per cycle by the separation-pushing plate module 120. Therefore, two cycles of the separation-pushing plate module 120 may push out the 50 plastic parts 200. It is noted that the plastic parts 200 pushed out from the second row collecting rack set 117 are stacked on top of the plastic parts 200 previously pushed out from the first row collecting rack set 116. The two sets of the 25 plastic parts 200 pushed out sequentially are stacked together. Although the above example describes stacking two sets of plastic parts 200 for packaging, the present disclosure is not limited in this regard. The number of push-out steps of the plastic parts 200 at one time may be three or more. However, in order to reduce complexity, the design typically adopts an even number of push-out steps to stack multiple the plastic parts 200.

Specifically, after the flipping module 110 of the product collection device 100 receives the plastic parts 200, the flipping jig 114 of the flipping module 110 can be flipped by the rotating element 112 by 90 degrees to interact with the separation-pushing plate module 120, such that the inlets 119 of the first row collecting rack set 116 and the second row collecting rack set 117 may be transformed from being parallel to the first direction D1 to being parallel to the second direction D2. In addition, the pushing plate 124 of the separation-pushing plate module 120 can be aligned with the first row collecting rack set 116. The multi-link assembly 122 drives the pushing plate 124 to move along the second direction D2 to push out the plastic parts 200 in the first row collecting rack set 116. Then, the multi-link assembly 122 of the separation-pushing plate module 120 drives the pushing plate 124 to move along the second direction D2 such that the pushing plate 124 aligns with the second row collecting rack set 117 and then pushes out the plastic parts 200 in the second row collecting rack set 117. In this way, the plastic parts 200 pushed out by the pushing plate 124 in two steps can be delivered to a packaging equipment for packaging, thereby improving overall operating efficiency.

In some embodiments, the product collection device 100 further includes a second conveying module 140. The second conveying module 140 is disposed at the side of the flipping module 110 opposite from the separation-pushing plate module 120 and is configured to receive the plastic parts 200 pushed out by the pushing plate 124 of the separation-pushing plate module 120 from the first row collecting rack set 116 and the second row collecting rack set 117. Furthermore, the second conveying module 140 includes a plurality of plastic collection slots 141. First, a plastic collection slot 141 may receive the plastic parts 200 pushed out from the first row collecting rack set 116. Then, the same plastic collection slot 141 may receive the plastic parts 200 pushed out from the second row collecting rack set 117. A single plastic collection slot 141 may receive plastic parts 200 from two sequential push-out steps. Subsequently, another plastic collection slot 141 may receive the next set of the plastic parts 200 pushed out from the first row collecting rack set 116 and the second row collecting rack set 117. Therefore, each plastic collection slot 141 may receive the 50 plastic parts 200 (a half of the plastic parts 200 from the first row and another half of the plastic parts 200 from the second row. As previously described, the plastic collection slots 141 may be designed to receive the plastic parts 200 from three or more push-out steps.

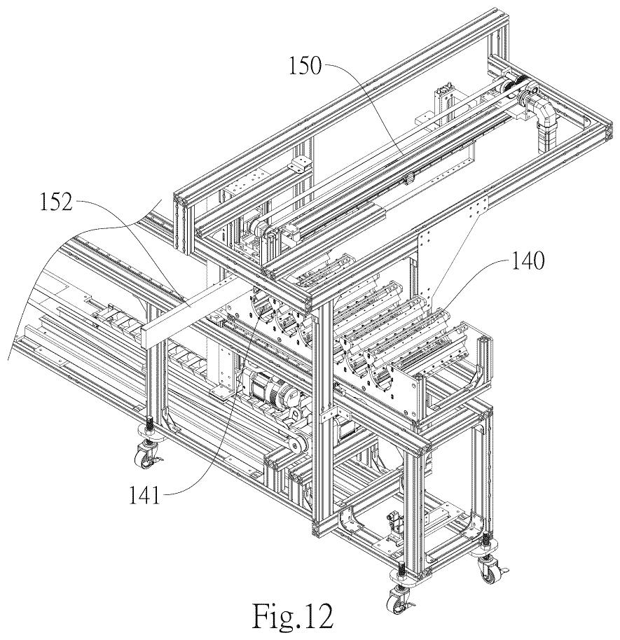

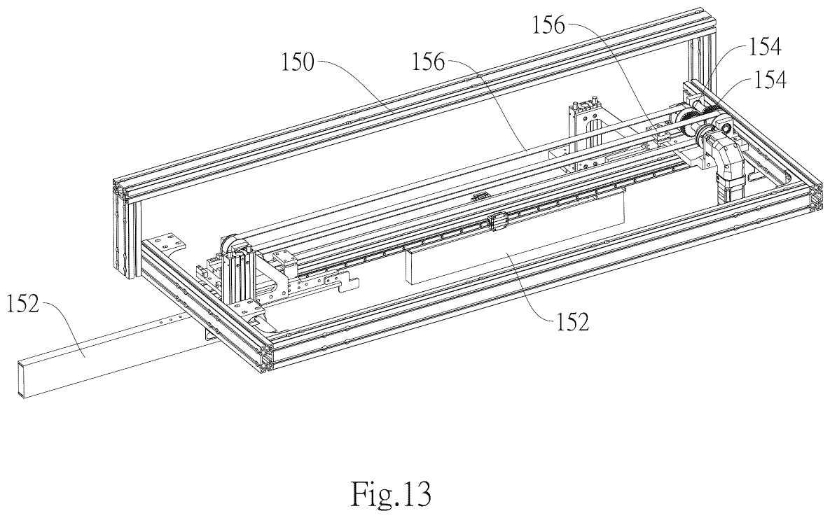

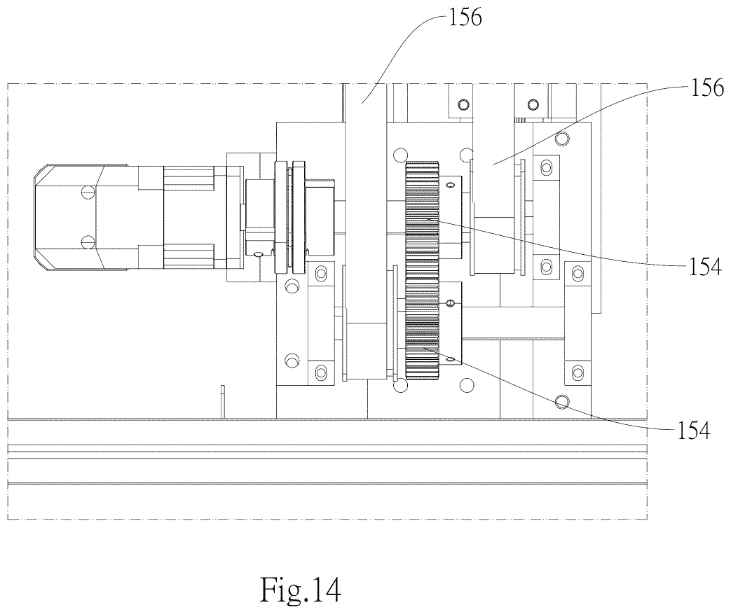

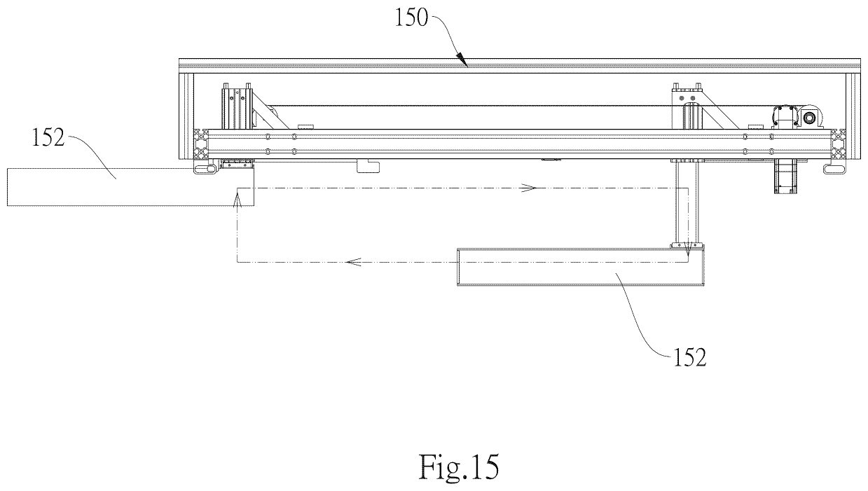

Please refer to FIG. 12 to FIG. 15, FIG. 12 is a schematic view illustrating that a conveyor pushing set 150 is operated according to an embodiment of the present disclosure, FIG. 13 is a perspective view of the conveyor pushing set 150, FIG. 14 is a side view of the conveyor pushing set 150, and FIG. 15 is a schematic view illustrating that conveyor pushing plates 152 of the conveyor pushing set 150 are operated. As shown in FIG. 12 to FIG. 15, the product collection device 100 further includes the conveyor pushing set 150. The conveyor pushing set 150 is disposed at one side of the second conveying module 140 and includes two conveyor pushing plates 152 which are opposite to each other. The two conveyor pushing plates 152 of the conveyor pushing set 150 are configured to push out the plastic parts 200 received in the plastic collection slots 141 of the second conveying module 140, so that the plastic parts 200 can be transferred to a subsequent packaging equipment.

In addition, the conveyor pushing set 150 further includes two gears 154 and two belts 156 respectively corresponding to the two gears 154. The two gears 154 of the conveyor pushing set 150 may be driven by a power source which drives the two gears 154 to rotate. The two belts 156 are respectively driven by the two gears 154. The two belts 156 are driven by the two gears 154 to reciprocally move the two conveyor pushing plates 152. As a result, the conveyor pushing plates 152 can alternately push out the plastic parts 200 received in the plastic collection slots 141 of the second conveying module 140. The subsequent packaging equipment may package the plastic parts 200 from the conveyor pushing plates 152.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A product collection device for collecting and transporting a plurality of plastic parts, comprising:
a flipping module, having a rotating element and a flipping jig pivotally connected to the rotating element, wherein the flipping jig comprises a first row collecting rack set and a second row collecting rack set adjacent to the first row collecting rack set, after the first row collecting rack set and the second row collecting rack set receive the plurality of the plastic parts, the flipping jig is flipped by the rotating element, such that a plurality of inlets of the first row collecting rack set and the second row collecting rack set are transformed from being parallel to a first direction to being parallel to a second direction, and the first direction is perpendicular to the second direction; and
a separation-pushing plate module, disposed at one side of the flipping module and having a multi-link assembly and a pushing plate connected to the multi-link assembly, wherein after the flipping module is flipped such that the plurality of the inlets are parallel to the second direction, the pushing plate is aligned with the first row collecting rack set, and the multi-link assembly drives the pushing plate to move along the second direction to push the plurality of the plastic parts in the first row collecting rack set through the plurality of the inlets, wherein the multi-link assembly drives the pushing plate to move so that the pushing plate is aligned with the second row collecting rack set, and the multi-link assembly of the separation-pushing plate module drives the pushing plate to move along the second direction to push the plurality of the plastic parts in the second row collecting rack set through the plurality of the inlets.

2. The product collection device of claim 1, wherein the plurality of the plastic parts pushed out from the second row collecting rack set are stacked onto the plurality of the plastic parts previously pushed out from the first row collecting rack set.

3. The product collection device of claim 1, further comprising:
a first conveying module, disposed at one side of the flipping module and configured to convey the plurality of the plastic parts to the first row collecting rack set and the second row collecting rack set of the flipping jig.

4. The product collection device of claim 3, wherein the first conveying module comprises a moving platform set and a lifting jig disposed on the moving platform set, and the moving platform set is configured to move the lifting jig so as to align the lifting jig with the flipping jig of the flipping module along the first direction.

5. The product collection device of claim 4, wherein the lifting jig of the first conveying module comprises a plurality of board brushes, and the plurality of the board brushes are configured to secure the plurality of the plastic parts within the lifting jig.

6. The product collection device of claim 5, wherein the board brushes of the first conveying module are disposed around a bottom portion of the lifting jig.

7. The product collection device of claim 2, further comprising:
a second conveying module, disposed at one side of the flipping module opposite to the separation-pushing plate module, configured to receive the plurality of the plastic parts pushed by the pushing plate of the separation-pushing plate module from the first row collecting rack set and second row collecting rack set.

8. The product collection device of claim 7, wherein the second conveying module comprises a plurality of plastic collection slots, each one of the plurality of the plastic collection slots is configured to sequentially receive the plurality of the plastic parts pushed from the first row collecting rack set and then receive the plurality of the plastic parts pushed from the second row collecting rack set, and another one of the plurality of the plastic collection slots is configured to receive the plurality of the plastic parts which may be pushed next from the first row collecting rack set and the second row collecting rack set.

9. The product collection device of claim 8, further comprising:
a conveyor pushing set, disposed at one side of the second conveying module and having two opposite conveyor pushing plates, wherein the two conveyor pushing plates are configured to push out the plurality of the plastic parts received in the plurality of the plastic collection slots of the second conveying module, such the plurality of the plastic parts are configured to be packaged subsequently by a packaging equipment.

10. The product collection device of claim 9, wherein the conveyor pushing set comprises two gears and two belts respectively corresponding to the two gears, and the two belts are driven by the two gears to reciprocally move the two conveyor pushing plates.
